(19) United States
(12) Patent Application Publication
(10) Pub. No.: US 2008/0271160 A1
(43) Pub. Date: Oct. 30, 2008

(54) METHOD AND SYSTEM FOR PUBLICATION CONTROL OF DIGITAL CONTENT

(75) Inventors: Zhefeng Yan, Shenzhen (CN); Fangshan Wang, Shenzhen (CN); Jin Peng, Shenzhen (CN); Fenglei Wang, Shenzhen (CN); Haohua Chen, Shenzhen (CN); Tieying Wang, Shenzhen (CN)

Correspondence Address: DARBY & DARBY P.C., P.O. BOX 770, Church Street Station, New York, NY, 10008-0770, US

(73) Assignee: HUAWEI TECHNOLOGIES CO., LTD., Shenzhen (CN)

(21) Appl. No.: 12/170,008

(22) Filed: Jul. 9, 2008

Related U.S. Application Data
(63) Continuation of application No. PCT/CN2006/002728, filed on Oct. 17, 2006.

(30) Foreign Application Priority Data
Feb. 20, 2006 (CN) 200610009190.9

(51) Int. Cl. G06F 21/00

(52) U.S. Cl. 726/27

(57) ABSTRACT

A method and system for publication control of digital content for validating the rights information registered by a plurality of separate content providers. When receiving a digital content publication application from a content publication unit, a publication control unit queries whether rights information corresponding to the digital content to be published is stored in a rights publication unit, and if stored, allows the publication of the digital content and of a download address thereof. By messaging rights information in this centralized manner, it may be ensured that a content buyer can efficiently obtain the rights object distributed after the digital content is published.

### CROSS REFERENCE TO RELATED APPLICATIONS

This application is a Continuation of PCT/CN2006/002728, filed on Oct. 17, 2006, and claims the benefit of Chinese Patent Application No. 200610009190.9, filed on Feb. 20, 2006, both of which are incorporated in their entireties herein. The PCT application published in Chinese on Aug. 30, 2007 as WO 2007/095798 A1.

### FIELD OF THE INVENTION

The disclosure relates to digital content publication technology, and in particular, to a method and system for publication control of digital content.

### BACKGROUND OF THE INVENTION

Publication of digital content over network may be implemented by sharing within a local area network and file transmission over the Internet. In such cases, a terminal is required to know an opposite terminal and has to be authorized by the opposite terminal. This imposes a restriction on sharing. At present, there emerge a number of Peer to Peer (P2P) file sharing modes, therefore a terminal may obtain a shared file by only a search of the desired content.

With the emergence and development of mobile networks, some functions of personal computers (PCs) are shifting to mobile terminals. P2P is being applied for instant communication, content publication, and file search, and provides a good platform for utilizing network resources efficiently. The continual improvement of P2P has alleviated the burden on a server, so that the server may serve as a front end communication device only. In addition, P2P provides a platform for the users to query desired information, and ensures end-to-end connectivity.

Digital content may be transmitted over network in a variety of ways. A portion of shared digital content may be transmitted illegally after publication, due to the lack of adequate copy controls. This case often arouses conflicts between copyright protection and benefit from information access. However, there is not an effective method for preventing such a case at present. Particularly for an individual content provider, the works of the provider can not be protected effectively. As a result, the content provider may lose his/her enthusiasm for creating and distributing his/her works absent effective protection.

Digital Rights Management (DRM) is a technique directed to management and licensing of intellectual rights of digital content. The digital content includes media content, such as electronic books, audios, and images. Licensing may be enforced by controlling the access to the digital content and encrypting the digital content. The encrypted digital content may be transmitted over network by P2P, while the rights of the digital content may be protected. DRM is a technology for digital content contribution, promotion, and sale over networks by encryption.

FIG. 1 is a schematic diagram illustrating a typical structural model of a DRM system 100. As shown in FIG. 1, the DRM system includes a content publication unit 10, a rights publication unit 30 and a DRM agent unit 40. The content publication unit 10 and the rights publication unit 30 belong to the same owner (i.e. a service provider). The content publication unit 10 and the rights publication unit 30 may be two function components in one function entity, or may be two separated function entities. In other words, they need not be strictly separated physically. The content publication unit 10 is configured to provide encrypted and packaged digital content to the DRM agent unit 40, and deliver rights information of the digital content, including a content key of the digital content, to the rights publication unit 30. The rights publication unit 30 is configured to, according to the rights of the user subscribed to the digital content, provide a Rights Object (RO), which specifies a purview for a user to use the digital content, to encapsulate the content key into the RO by encryption, and to deliver the rights object to the DRM agent unit 40. After receiving the rights object, a DRM terminal (not illustrated) acquires the content key by decryption, decrypts the encrypted digital content distributed from the content publication unit 10 to obtain the original digital content, and utilizes the digital content according to the purview specified by the rights object. To sum up, the content publication unit 10 is configured to encrypt and package the digital content provided by a content provider, deliver related rights information to the rights publication unit 30, and distribute the encrypted digital content to the DRM agent unit 40. The rights publication unit 30 is configured to generate an RO and publish the authorization of rights of digital content.

In the above solution, the content publication unit and the rights publication unit belong to the same owner (i.e. the service provider). This may not apply to a content publication system having a plurality of separate content providers. The content publication system having a plurality of separate content providers controls the publication of digital content by the following ways, the particular implementations of which will be described as follows.

Content publication units of the separate content providers select their own digital content to be published, while a centralized rights publication unit generates the RO and publishes authorization. In this scenario, each of the separate content publication units is configured to encrypt and package the digital content, and deliver the related rights information to the centralized rights publication unit. The centralized rights publication unit may be required to serve a number of content publication units. If a content publication unit does not register its rights or the registration is failed before publishing the digital content, the rights publication unit can not generate a rights object due to the lack of related record of the digital content. As a result, a user can not decrypt the digital content when obtaining the encrypted digital content; or, the digital content can not be protected.

### SUMMARY OF THE INVENTION

A method and system for publication control of digital content, employed for validating the rights information registered by separated content providers, to solve the problem that a user can not decrypt a piece of digital content after downloading the digital content or that the digital content can not be protected because the rights are not registered or the registration is failed.

Technical solutions embodying the present invention include the following.

A method for publication control of digital content includes the steps of:
encrypting, by a content publication unit, a piece of digital content to be published to form encrypted digital content, and sending rights information of the encrypted digital content to a rights publication unit to store the rights information in the rights publication unit; and
when receiving a digital content publication application from the content publication unit, querying, by a publication control unit, whether the rights information corresponding to the digital content to be published is stored in the rights publication unit, and allowing to publish the digital content or a download address of the digital content of the content publication unit if the rights information corresponding to the digital content to be published is stored in the rights publication unit.

A system for publication control of digital content includes:
a rights publication unit, adapted to save rights information of digital content; and
and the system further includes:
a content publication unit, adapted to send a digital content publication application to a publication control unit; and
a publication control unit, adapted to query whether rights information corresponding to the digital content to be published is stored in the rights publication unit when receiving the digital content publication application from the content publication unit, and to allow the content publication unit to publish the digital content or a download address of the digital content if the rights information corresponding to the digital content to be published is stored in the rights publication unit.

A publication control unit includes:
a rights information query sub-unit, adapted to query whether rights information corresponding to digital content to be published is stored in a rights publication unit when receiving a digital content publication application from a content publication unit, and allow the content publication unit to publish the digital content or a download address of the digital content if the rights information corresponding to the digital content to be published is stored in the rights publication unit; and
a publication sub-unit, adapted to receive description information and the download address of the digital content to be published, or the encrypted digital content and the description information of the digital content to be published, delivered from the content publication unit.

A content publication unit includes:
a rights information sending sub-unit, adapted to send rights information of digital content to a rights publication unit to register and save the rights information in the rights publication unit; and
a publication application sub-unit, adapted to send a digital content publication application to a publication control unit.

Some beneficial effects as further described within the disclosure are as follows:

Each separated content provider in a digital content publication system having a plurality of separated content providers is provided with services for rights registration and validation. In this way, the unreliability of content utilization and authorization due to limitations and instabilities in system capability may be avoided. In addition, it may be ensured that a content buyer can obtain the rights object distributed by the rights publication unit after the digital content is published, in order to reproduce the digital content.

Moreover, when a content provider modifies the description information of the digital content stored in the rights publication unit, the publication control unit may obtain the modified description information in time, so as to update the published description information of the digital content. In this way, the description information of the digital content as seen by users is maintained to be consistent with the actual digital content.

### BRIEF DESCRIPTION OF THE DRAWINGS

The invention will become more readily apparent from the Detailed Description of the Invention, which proceeds with reference to the drawings, in which:

FIG. 1 is a schematic diagram illustrating a typical structural model of a DRM system in the prior art;

FIG. 2 is a flow chart illustrating a process of registering digital content in a rights publication unit by a content publication unit according to an embodiment;

FIG. 3 is a flow chart illustrating a method for publication control of digital content according to one embodiment;

FIG. 4 is a flow chart illustrating a method for publication control of digital content according to another embodiment;

FIG. 5 is a flow chart illustrating a process of sending modified description information of digital content to a publication control unit by a content publication unit to thereby update published description information according to an embodiment;

FIG. 6 is a flow chart illustrating a process of obtaining modified description information from a rights publication unit by a publication control unit to thereby update the published description information according to an embodiment;

FIG. 7 is a flow chart illustrating a process of sending modified description information of digital content to a publication control unit corresponding to the digital content by a rights publication unit according to an embodiment; and

FIG. 8 is a schematic diagram illustrating the structure of a system for publication control of content according to an embodiment.

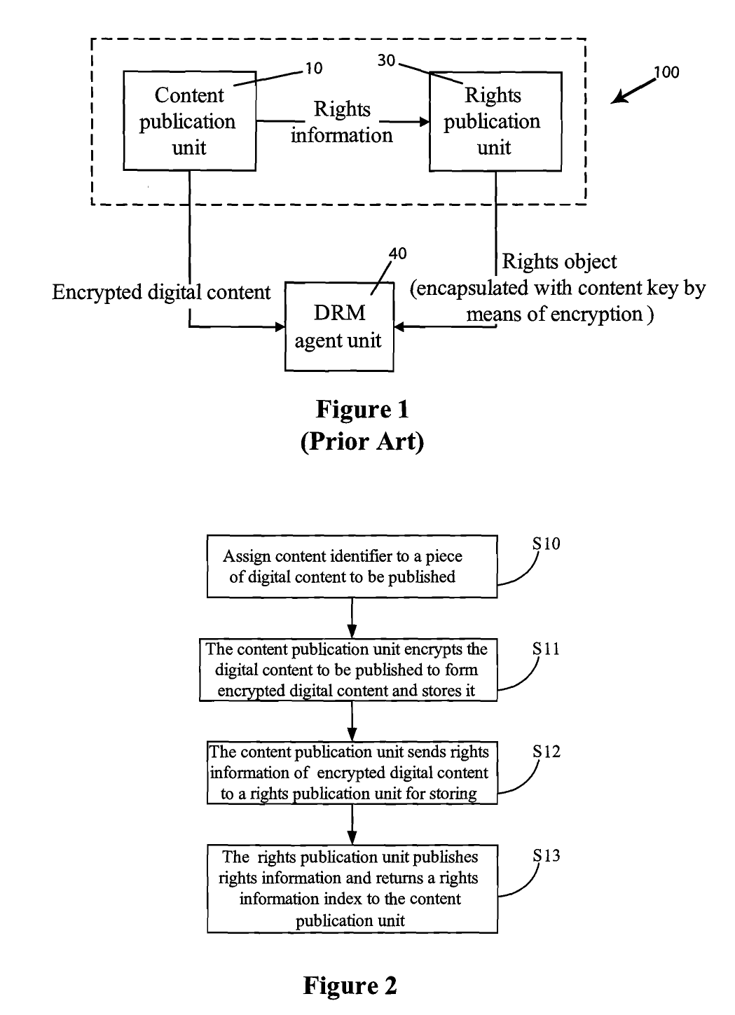

### DETAILED DESCRIPTION OF THE INVENTION

The present invention provides a method and system for publication control of digital content, in which rights information of digital content registered by each content provider is validated before publication of the digital content, in a digital content publication system having a plurality of separated content providers. In this way, the digital content registered by each content provider may be protected in a digital content publication system having a plurality of separated content providers; and a content buyer is able to obtain the rights object distributed by a rights publication unit after the digital content is published, so as to reproduce the digital content.

Several exemplary embodiments of the present invention are described below in conjunction with the accompanying drawings.

FIG. 2 provides a flow chart illustrating a process of registering digital content in a rights publication unit by a content publication unit according to an exemplary embodiment of the present invention. In the embodiment shown by FIG. 2, the content publication unit and the rights publication unit belong to different owners. The process proceeds as follows.

In block S10, a piece of digital content to be published is assigned a content identifier.

A rights publication unit may assign the content identifier to the digital content according to a request from a content publication unit, and send the content identifier to the content publication unit. Or the content publication unit may assign the content identifier to the digital content by itself and report the content identifier to the rights publication unit.

In block S11, the content publication unit encrypts and packages the digital content to be published, to form encrypted digital content to be protected, and saves the encrypted digital content in the content publication unit, or entrusts other devices to save the encrypted digital content.

To ensure that a user may decrypt the encrypted digital content successfully, the content publication unit may report an encryption algorithm to be used to the rights publication unit, and may obtain an acknowledgement from the rights publication unit, before encrypting the digital content with the encryption algorithm. Alternatively, the content publication unit may request the rights publication unit to designate an encryption algorithm to be used.

A predefined encryption algorithm identifier may be employed during the above procedure of the report, acknowledgement and the designation of the encryption algorithm between the content publication unit and the rights publication unit.

In block S12, the content publication unit sends rights information of the encrypted digital content to the rights publication unit, to register and store the rights information in the rights publication unit.

The rights information includes identifier information of the digital content, and may also include an identifier of a rights owner, as well as a key of the encrypted digital content. Furthermore, the rights information may include description information of the digital content.

In block S13, after storing the rights information of the encrypted digital content, the rights publication unit returns a rights information index to the content publication unit.

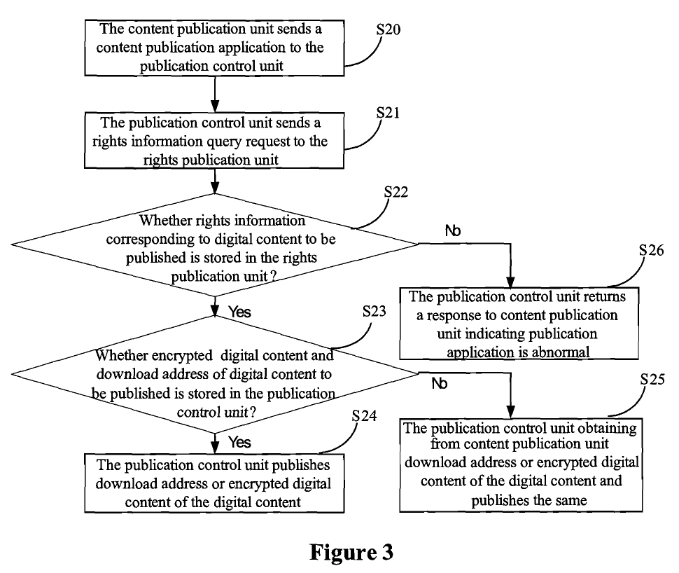

FIG. 3 provides a flow chart illustrating a method for publication control of digital content according to an exemplary embodiment of the present invention. As shown in FIG. 3, the method is as follows.

In block S20, the content publication unit sends a content publication application to a publication control unit. When a content provider wishes to publish a piece of digital content, a content publication unit of the content provider sends a content publication application to a publication control unit. The content publication application carries at least a content identifier or a rights information index of the digital content to be published. Alternatively, the content publication application may also carry description information and a download address of the digital content, or may also carry the encrypted digital content and the description information of the digital content. The description information may include a content introduction, size, format and charging information of the digital content.

In block S21, the publication control unit sends a rights information query request to the rights publication unit. When receiving the content publication application, the publication control unit temporarily saves the description information and download address of the digital content, or the encrypted digital content and the description information of the digital content, if the content publication application carries the description information and download address of the digital content, or carries the encrypted digital content and the description information of the digital content, and sends a rights information query request to the rights publication unit according to the content identifier or the rights information index of the digital content to be published, to query whether the rights information corresponding to the digital content to be published is stored in the rights publication unit.

In block S22, the rights publication unit determines whether it stores rights information corresponding to digital content to be published. When receiving the rights information query request, the rights publication unit records a mapping relationship between the content identifier or the rights information index of the digital content and an identifier of the publication control unit, and queries whether the rights information is stored in the rights publication unit according to the content identifier or the rights information index of the digital content carried in the rights information query request. If the rights information is stored in the rights publication unit, the process proceeds to block S23, otherwise, the process proceeds to block S26.

In block S23, the publication control unit determines whether it stores the encrypted digital content and download address of digital content to be published. The publication control unit judges whether the description information and download address of the digital content, or the encrypted digital content and the description information of the digital content are temporarily saved in the publication control unit. If saved, the process proceeds to block S24, otherwise, the process proceeds to block S25.

In block S24, the publication control unit publishes a download address or encrypted digital content of the digital content. The publication control unit publishes the description information and the download address of the digital content to be published, or the encrypted digital content and the description information of the digital content to be published, and sends a publication completion message to the content publication unit after the publication is completed.

In block S25, the publication control unit obtains the download address or encrypted digital content of the digital content from content publication unit and publishes the same. The publication control unit sends a response message to the content publication unit indicating that the publication of the digital content is allowed. When receiving the response message, the content publication unit publishes or delivers a content introduction, charging information and the download address of the digital content, or the encrypted digital content, the content introduction and the charging information of the digital content to the publication control unit, so that the publication control unit may publish the content introduction, the charging information and the download address of the digital content, or the encrypted digital content, the content introduction and the charging information of the digital content. After the publication is completed, the publication control unit sends a publication completion message to the content publication unit.

In block S26, the publication control unit returns a response to content publication unit indicating that the publication application is abnormal. The publication control unit returns a response message, indicating that publication application is abnormal, to the content publication unit sending the content publication application.

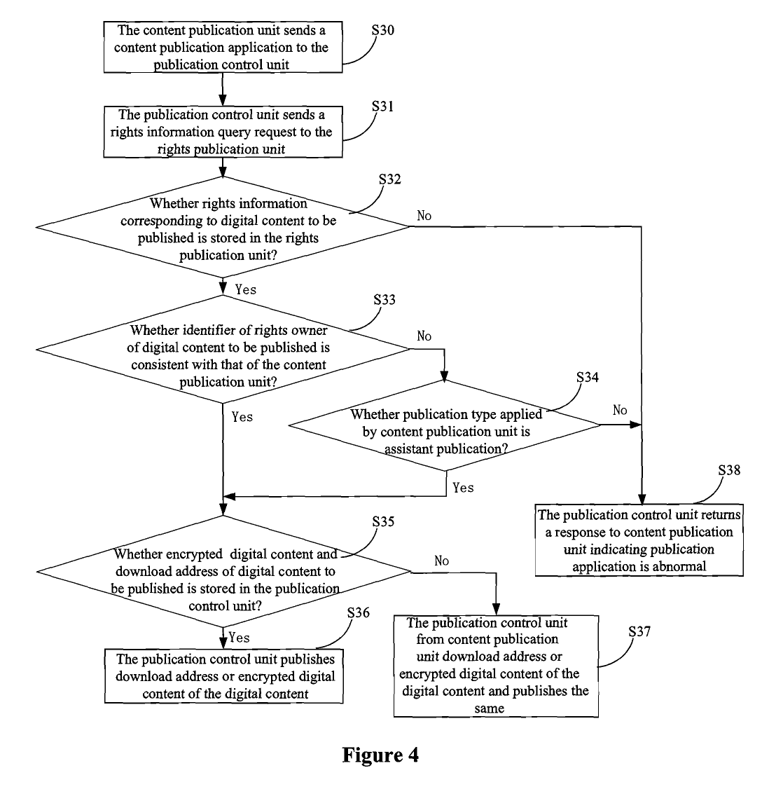

FIG. 4 is a flow chart illustrating a method for publication control of digital content according to another embodiment of the present invention. As shown in FIG. 4, the method is as follows.

In block S30, the content publication unit sends a content publication application to the publication control unit. When a content provider wishes to publish a piece of digital content, a content publication unit of the content provider sends a content publication application to a publication control unit. The content publication application carries a content identifier or a rights information index of the digital content to be published, and identification information of the content provider sending the content publication application. Optionally, the content publication application may also carry description information and a download address of the digital content, or may also carry the encrypted digital content and the description information of the digital content. The description information includes a content introduction, size, format and charging information of the digital content.

In block S31, the publication control unit sends a rights information query request to the rights publication unit (as in S21 of FIG. 3).

In block S32, the rights publication unit determines whether it stores rights information corresponding to digital content to be published. When receiving the rights information query request, the rights publication unit records a mapping relationship between the content identifier or the rights information index of the digital content applied to be published and an identifier of the publication control unit, and queries whether the rights information is stored in the rights publication unit according to the content identifier or the rights information index of the digital content carried in the rights information query request. If the rights information is stored in the rights publication unit, the process proceeds to block S33, otherwise, the process proceeds to block S38.

In block S33, the rights publication control unit determines whether it stores an identifier of rights owner of digital content to be published that is consistent with that of the content publication unit. The publication control unit judges whether a rights owner identifier of the digital content to be published is consistent with an identifier of content provider of the digital content to be published. If it is consistent, the process proceeds to block S35, otherwise the process proceeds to block S34.

In block S34, the publication control unit judges whether a publication type for publishing the digital content applied by the content publication unit is the type “assistant publication.” If the type is assistant publication, the process proceeds to block S35, otherwise the process proceeds to block S38.

In block S35, the publication control unit judges whether the description information and download address of the digital content, or the encrypted digital content and the description information of the digital content are temporarily saved in the publication control unit. If this information is stored in the publication control unit, the process proceeds to block S36, otherwise, the process proceeds to block S37.

In block S36, the publication control unit publishes a download address or encrypted digital content of the digital content. The publication control unit publishes the description information and the download address of the digital content applied to be published, or the encrypted digital content and the description information of the digital content, and sends a publication completion message to the content publication unit after the publication is completed.

In block S37, the publication control unit sends a response message to the content publication unit indicating that the publication of the digital content is allowed. When receiving the response message, the content publication unit delivers the content introduction, the charging information and the download address of the digital content, or the encrypted digital content, the content introduction and the charging information of the digital content to the publication control unit, so that the publication control unit may publish the content introduction, the charging information and the download address of the digital content, or the encrypted digital content, the content introduction and the charging information of the digital content. After the publication is completed, the publication control unit sends a publication completion message to the content publication unit.

In block S38, the publication control unit returns a response to the content publication unit indicating that the publication application is abnormal (as in S26 of FIG. 3).

In practical application, the description of the digital content is managed by the rights publication unit, while the publication control unit is responsible for publishing the description information. If the content publication unit modifies the description information of the digital content stored in the rights publication unit, the publication control unit is required to know the modified description information in time, so as to update the published description information of the digital content.

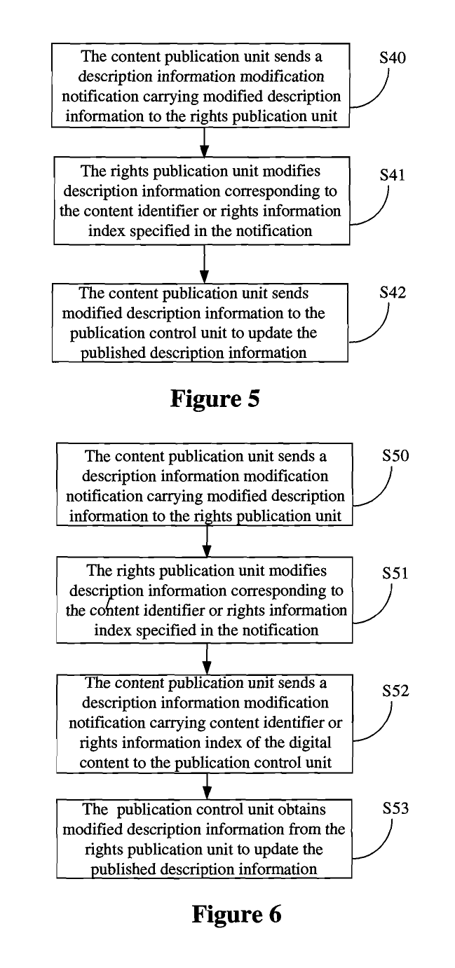

FIG. 5 is a flow chart illustrating a process of sending modified description information of digital content to a publication control unit by a content publication unit to thereby update the published description information according to an embodiment. As shown in FIG. 5, the process is as follows.

In block S40, the content publication unit sends a description information modification notification carrying modified description information to the rights publication unit. The description information modification notification specifies a content identifier or a rights information index of the digital content corresponding to modified description information, as well as the modified description information.

In block S41, the rights publication unit modifies description information corresponding to the content identifier or rights information index specified in the notification. When receiving the description information modification notification, the rights publication unit authenticates a purview of the content publication unit sending the description information modification notification. If it determines that the content publication unit has a purview for modification, the rights publication unit modifies the description information corresponding to the content identifier or the rights information index specified in the description information modification notification, and returns a success response to the content publication unit indicting the description information is modified successfully.

In block S42, the content publication unit sends modified description information to the publication control unit to update the published description information. When receiving the success response indicting that the description information has been modified successfully, the content publication unit sends the modified description information and the content identifier of the digital content corresponding to the modified description information to a publication control unit. Thereby, the publication control unit updates the published description of the digital content.

FIG. 6 is a flow chart illustrating a process of obtaining modified description information from a rights publication unit by a publication control unit after a content publication unit sends a description information modification notification to the publication control unit, to thereby update the published description information according to an embodiment. As shown in FIG. 6, the process is as follows.

Block S50 is the same as block S40 of FIG. 5 as described above.

Block S51 is the same as block S41 of FIG. 5 as described above.

In block S52, when receiving the success response indicting the description information has been modified successfully, the content publication unit sends to the publication control unit a description information modification notification carrying the content identifier or rights information index of the digital content.

In block S53, the publication control unit obtains the modified description information from the rights publication unit according to the content identifier or rights information index of the digital content, to thereby update the published description of the digital content.

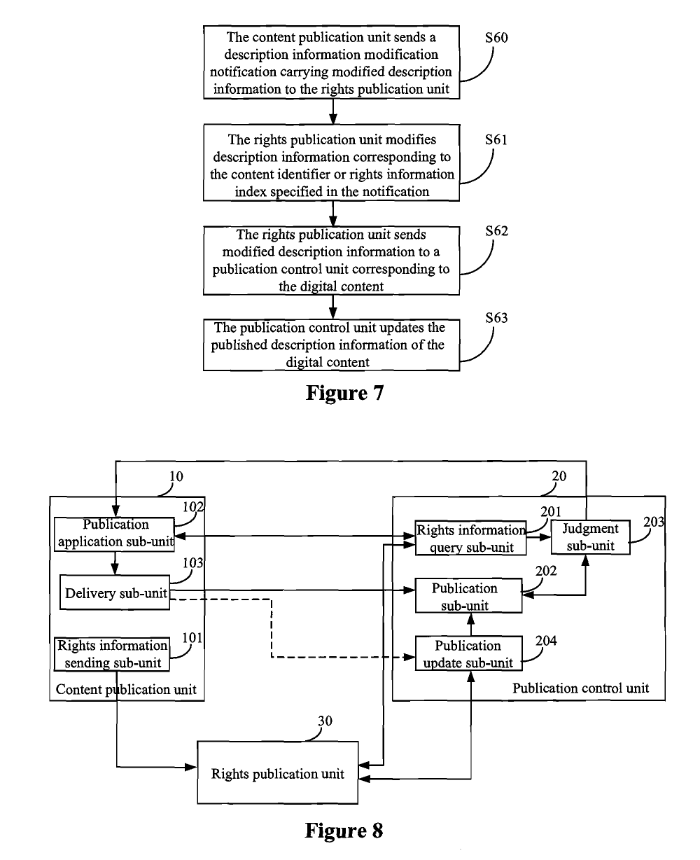

FIG. 7 is a flow chart illustrating a process of sending modified description information of digital content to a publication control unit corresponding to the digital content by a rights publication unit and updating published description information by the publication control unit according to an embodiment of. As shown in FIG. 7, the process is as follows.

Block S60 is the same as block S40 of FIG. 5 as described above.

Block S61 is the same as block S41 of FIG. 5 as described above.

In block S62, the rights publication unit sends a description information modification notification to a publication control unit corresponding to the digital content to be published according to the mapping relationship between the content identifier or rights information index of the digital content recorded in the above blocks S22 or S32. The description information modification notification may carry the modified description information of the digital content. Alternatively, the description information modification notification does not carry the modified description information. If the description information modification notification does not carry the modified description information of the digital content, the publication control unit may acquire the modified description information of the digital content from the rights publication unit, the process proceeds to block S43. If the description information modification notification carries the modified description information of the digital content, the process proceeds to block S63.

In block S63, the publication control unit updates the published description of the digital content.

FIG. 8 is a schematic diagram illustrating the structure of a system for publication control of content according to an embodiment. The system includes a content publication unit 10, a publication control unit 20 and a rights publication unit 30. The functions of the units are described as follows.

The content publication unit 10 is adapted to send a digital content publication application to the publication control unit 20, and may be disposed in a separate content provider system.

The publication control unit 20 is adapted to control the publication of the digital content. When receiving the digital content publication application message from the content publication unit 10, the publication control unit 20 queries rights information corresponding to the digital content to be published in the rights publication unit 30, and controls the publication of the digital content according to the result of the query.

The rights publication unit 30 is adapted to save the rights information of the digital content.

In some exemplary embodiments of the present invention, the content publication unit 10 may include:

a rights information sending sub-unit 101, adapted to send the rights information of the digital content to the rights publication unit 30 to register and save the rights information in the rights publication unit 30;

a publication application sub-unit 102, adapted to send the digital content publication application to the publication control unit 20; and

the delivery sub-unit 103, adapted to deliver description information and a download address of the digital content to be published, or encrypted digital content and the description information of the digital content, to the publication control unit 20.

In some other exemplary embodiments of the present invention, the publication control unit 20 may include:

a rights information query sub-unit 201, adapted to query whether the rights information corresponding to the digital content to be published is stored in the rights publication unit 30 when receiving the digital content publication application from the content publication unit, and to allow the content publication unit to publish the digital content or the download address of the digital content if the rights information corresponding to the digital content to be published is stored in the rights publication unit 30; and

a publication sub-unit 202, adapted to receive the description information and the download address of the digital content to be published, or the encrypted digital content and the description information of the digital content, delivered from the content publication unit 10.

In some embodiments of the present invention, the content publication unit 10 sending the digital content publication application is required to have a purview of publishing the digital content. In other words, the content publication unit 10 sending the digital content publication application should be a rights owner or an assistant publisher of the digital content. To judge whether the content publication unit 10 sending the digital content publication application has the purview of publishing the digital content, and whether the content publication unit 10 sending the digital content publication application is a rights owner or an assistant publisher of the digital content, the publication control unit 20 may further include:

a judgment sub-unit 203, adapted to judge whether the content publication unit 10 sending the digital content publication application is the rights owner of the digital content according to the rights information queried by the rights information query sub-unit 201. If the content publication unit 10 is the rights owner of the digital content, the judgment sub-unit 203 allows the content publication unit 10 to publish the digital content or the download address of the digital content. Otherwise, the judgment sub-unit 203 further judges whether the content publication unit 10 sending the digital content publication application is an assistant publisher of the digital content. If the content publication unit 10 is the assistant publisher of the digital content, the judgment sub-unit 203 allows the content publication unit 10 to publish the digital content or the download address of the digital content. Otherwise, it returns a response message indicating that publication application is abnormal to the content publication unit 10.

In some practical application, the description information of the digital content (such as content introduction, size, format and charging information of the digital content) is managed by the rights publication unit 30, while the publication control unit 20 is responsible for publishing the description information of the digital content. If the content publication unit 10 modifies the description information of the digital content stored in the rights publication unit 30, the publication control unit 20 is required to know the modified description information in time, so as to update the published description information of the digital content, so that the description information saw by a user is maintained consistent with the actual digital content. In this embodiment, the publication control unit 20 may further include:

a publication update sub-unit 204, adapted to receive the modified description information, and control the publication sub-unit 202 to update the published description information according to the modified description information of the digital content. In this way, the published description information of the digital content may be updated in time when the description information of the digital content changes.

For other details regarding the system for publication control of digital content according to the embodiments, the corresponding details described in the method embodiments may be referred to, which will not be repeated herein.

A person of ordinary skill in the art may make various modifications and variations to the invention without departing the spirit and scope of the invention. These modifications and variations to the invention are intended to be covered within the scope of the invention provided that the modifications and variations fall within the scope of the claims of the invention. The foregoing description is illustrative and not limiting, and is intended to include all reasonably foreseeable equivalents to the directly described features within the scope of the invention as defined by the claims.

What is claimed is:

1. A method for publication control of digital content, comprising the steps of:
when receiving a digital content publication application from a content publication unit, querying, by a publication control unit, whether rights information corresponding to the digital content to be published is stored in a rights publication unit; and
allowing publication of the digital content or a download address of the digital content of the content publication unit if the rights information corresponding to the digital content to be published is stored in the rights publication unit.

2. The method according to claim 1, further comprising the steps of:
encrypting, by the content publication unit, a piece of digital content to be published to form encrypted digital content; and
sending rights information of the encrypted digital content to the rights publication unit to store the rights information in the rights publication unit.

3. The method according to claim 1, wherein the rights information comprises identifier information of the digital content.

4. The method according to claim 2, further comprising:
returning, by the rights publication unit, a rights information index to a content publication unit after the rights information is stored in the rights publication unit.

5. The method according to claim 4, wherein
the digital content publication application carries identifier information or the rights information index of the digital content to be published; and
the querying step to determine whether the rights information corresponding to the digital content to be published is stored in the rights publication unit is performed by the publication control unit according to the identifier information or the rights information index of the digital content to be published.

6. The method according to claim 3, wherein the rights information further comprises identifier information of a rights owner of the digital content and a key of the encrypted digital content.

7. The method according to claim 6, wherein if the rights information corresponding to the digital content to be published is stored in the rights publication unit, the method further comprises the steps of:
judging, by the publication control unit, whether the content publication unit is a rights owner of the digital content, and allowing publication of the digital content or a download address of the digital content if the content publication unit is the rights owner of the digital content.

8. The method according to claim 7, wherein if the content publication unit is not the rights owner of the digital content, the method further comprises the steps of:
judging, by the publication control unit, whether a publication type applied by the content publication unit is an assistant publication,
allowing publication of the digital content or a download address of the digital content if the publication type applied by the content publication unit is an assistant publication, and
returning a response message indicating that publication application is abnormal if the publication type applied by the content publication unit is not an assistant publication.

9. The method according to claim 3, wherein the rights information further comprises description information of the digital content.

10. The method according to claim 9, wherein the description information comprises
a content introduction, size, format and charging information of the digital content.

11. The method according to claim 9, wherein
the digital content publication application carries the description information and a download address of the digital content; and
the method further comprises the steps of:
publishing, by the publication control unit, the description information and the download address of the digital content, if the rights information corresponding to the digital content to be published is stored in the rights publication unit.

12. The method according to claim 9, wherein
the digital content publication application carries encrypted digital content of the digital content and the description information of the digital content;
the method further comprises the steps of:
publishing, by the publication control unit, the encrypted digital content and the description information of the digital content, if the rights information corresponding to the digital content to be published is stored in the rights publication unit.

13. The method according to claim 11, wherein after publishing by the publication control unit of the description information of the digital content, the method further comprises the steps of:
modifying, by the content publication unit, the description information of the digital content stored in rights publication unit, and sending, by the content publication unit, the modified description information to the publication control unit, so that the publication control unit updates published description information of the digital content.

14. The method according to claim 11, wherein after publishing by the publication control unit of the description information of the digital content, the method further comprises the steps of:
modifying, by the content publication unit, the description information of the digital content stored in rights publication unit, and sending, by the content publication unit, a description information modification notification, carrying the identifier information or a rights information index of the digital content, to the publication control unit, and
obtaining, by the publication control unit, the modified description information from the rights publication unit according to the identifier information or the rights information index of the digital content, to update published description information of the digital content.

15. The method according to claim 11, wherein when querying by the publication control unit whether the rights information corresponding to the digital content to be published is stored in the rights publication unit, the method further comprises the steps of:
recording, by the rights publication unit, a mapping relationship between the content publication unit and the digital content.

16. The method according to claim 15, wherein after publishing by the publication control unit the description information of the digital content, the method further comprises the steps of:
modifying, by the content publication unit, the description information of the digital content stored in the rights publication unit, and
sending, by the rights publication unit, the modified description information to the publication control unit corresponding to the digital content, so that the publication control unit updates published description information of the digital content.

17. The method according to claim 1, further comprising the steps of:
returning a response message indicating that publication application is abnormal if the rights information corresponding to the digital content to be published is not stored in the rights publication unit.

18. A system for publication control of digital content, comprising:
a rights publication unit, adapted to save rights information for associated digital content;
wherein the system further comprises:
a content publication unit, adapted to send a digital content publication application to a publication control unit;
a publication control unit, adapted to query whether rights information corresponding to the digital content to be published is stored in the rights publication unit when receiving the digital content publication application message from the content publication unit, and to allow the content publication unit to publish the digital content or a download address of the digital content if the rights information corresponding to the digital content to be published is stored in the rights publication unit.

19. The system according to claim 18, wherein
the content publication unit comprises:
a rights information sending sub-unit, adapted to send the rights information of the digital content to the rights publication unit to register and save the rights information in the rights publication unit;
a publication application sub-unit, adapted to send the digital content publication application to the publication control unit; and
a delivery sub-unit, adapted to deliver description information and the download address of the digital content, or encrypted digital content and the description information of the digital content, to the publication control unit; and
the publication control unit includes:
a rights information query sub-unit, adapted to query whether the rights information corresponding to the digital content to be published is stored in the rights publication unit when receiving the digital content publication application from the content publication unit, and to allow the content publication unit to publish the digital content or the download address of the digital content if the rights information corresponding to the digital content to be published is stored in the rights publication unit; and
a publication sub-unit, adapted to receive the description information and the download address of the digital content to be published, or the encrypted digital content and the description information of the digital content to be published, delivered from the content publication unit.

20. The system according to claim 19, wherein the publication control unit further comprises:
a judgment sub-unit, adapted to judge whether the content publication unit sending the digital content publication application is a rights owner of the digital content according to the rights information; to allow the content publication unit to publish the digital content or the download address of the digital content if the content publication unit is the rights owner of the digital content, to further judge whether a publication type applied by the content publication unit sending the digital content publication application is an assistant publication if the content publication unit is not the right owner of the digital content; and to allow the content publication unit to publish the digital content or the download address of the digital content if the publication type is an assistant publication, or otherwise return a response message to the content publication unit indicating that the publication application is abnormal.

21. The system according to claim 19, wherein the publication control unit further comprises:
a publication update sub-unit, adapted to update published description information according to modified description information of the digital content.

22. A publication control unit, comprising:
a rights information query sub-unit, adapted to query whether rights information corresponding to digital content to be published is stored in a rights publication unit when receiving a digital content publication application from a content publication unit, and to allow the content publication unit to publish the digital content or a download address of the digital content if the rights information corresponding to the digital content to be published is stored in the rights publication unit.

23. The publication control unit according to claim 22, further comprising:
a publication sub-unit, adapted to receive description information and the download address of the digital content to be published, or encrypted digital content of the digital content and the description information of the digital content to be published, delivered from the content publication unit.

24. The publication control unit according to claim 23, further comprising:
a judgment sub-unit, adapted to judge whether the content publication unit sending the digital content publication application is a rights owner of the digital content according to the rights information; to allow the content publication unit to publish the digital content or the download address of the digital content if the content publication unit is the rights owner of the digital content, to further judge whether a publication type applied by the content publication unit sending the digital content publication application is an assistant publication if the publication unit is not the right owner of the digital content; to allow the content publication unit to publish the digital content or the download address of the digital content if the publication type is an assistant publication, or otherwise return a response message to the content publication unit indicating that the publication application is abnormal.

25. The publication control unit according to claim 23, further comprising:
a publication update sub-unit, adapted to update published description information according to modified description information of the digital content.

26. A content publication unit, comprising:
a rights information sending sub-unit, adapted to send rights information of digital content to a rights publication unit to register and save the rights information in the rights publication unit; and
a publication application sub-unit, adapted to sends a digital content publication application to a publication control unit.

27. The content publication unit according to claim 26, further comprising:
a delivery sub-unit, adapted to deliver description information and a download address of the digital content, or encrypted digital content and the description information of the digital content, to the publication control unit.
